(19) United States
(12) Patent Application Publication
(10) Pub. No.: US 2021/0051310 A1
(43) Pub. Date: Feb. 18, 2021

(54) THE 3D WIEVING AND RECORDING METHOD FOR SMARTPHONES

(71) Applicant: Hakan SAHIN, Izmir (TR)

(72) Inventor: Hakan SAHIN, Izmir (TR)

(21) Appl. No.: 17/043,754

(22) PCT Filed: Jan. 31, 2019
(86) PCT No.: PCT/TR2019/050063

§ 371 Date: Sep. 30, 2020

(51) Int. Cl. H04N 13/239; H04M 1/02; H04N 5/232; H04N 5/225

(52) U.S. Cl. CPC H04N 13/239; H04M 1/0264; H04M 2250/52; H04N 5/2258; H04N 5/23238

(57) ABSTRACT

The invention is about the smartphone (10) that can take photos and videos in 3D format and that is used in 360 VR (40) and that has double cameras (11 A-B) on front and double cameras (12 A-B) on backsides for taking 3D photos and videos.

### TECHNICAL FIELD

The invention is about the smartphone (10) that can take photos and videos in 3D format, is used in 360 VR (40) and that has double cameras (11 A-B) on front and double cameras (12 A-B) on back sides for taking 3-D photos and videos.

### BACKGROUND TECHNIQUE

3D or Stereoscopy is an attribution that how brain can sense 3rd dimension. There is approximately 50-75 mm distance between two eyes. So, two eyes see the same object in different angles because of this distance. It means that the views of two eyes are have different perspectives. That's why, brain percepts depth.

In a similar way, two cameras take and record films or videos in 3D. In other words, the images of the same object are captured by two different cameras at the same time. The main problem is how two images are shown on the display of PC, TV or smartphone. And then, we can see this two different images by using special eyeglasses. So we can sense the depth of picture.

3D image means that any picture/video that has height, width and depth. In computer language, we can call something a 3D image if it looks like real world images. For example, if you can move in computer game and can see to objects in different angles, this game can be called 3D game.

On the other hand, this method is used for architectural, endustrial or presentational 3D computer programs. So you can see a house, chair or machine part before it is not produced yet.

Besides, this method can be used as a training method for surgeries before the operation.

### Anaglyph Method:

This method is often used for displaying 3D content. In this method, two different colored lenses are used. One of them is red, and the other one is green or blue. So, the left eye sees left view through the blue lense and the right eye sees right view through the red lense. In this way, the brain combines the two images and creates 3D content.

| Advantages | Disadvantages |
|---|---|
| + cheap | − 3D images can not be seen by |
| + The extra specified | naked eye clearly |
| monitor is not necessary | − The extra specified goggle is |
| | required |

### Polarisation Method:

This method is the most common method in 3D viewing. It is commonly used in cinema industry. The left and right images are overlapped on the special screen using a different light polarisation method. Then the left and right images are separated for the left end right eyes are by using the light polarisation method. In other words, the lens on the one eye allows the horizontally polarised light, the other lens on the other eye allows the vertically polarised light.

| Advantages | Disadvantages |
|---|---|
| + Commonly used in | − The extra specified screen is required |
| cinema industry | − The filter of the lenses must be same |
| + Cheap polarised | with projection filter |
| goggles | − Goggles are required |
| + The colors are very | − Low quality in TV and monitors |
| natural | |

### LCD Shutter Google:

In this method, the left and right images are showed fastly and sequentially on screen. The shutter glasses are smart and there is a communication between glasses and screen. When the left image is on the screen, the left lens is open and the right lens is closed. When the right image is on the screen, the right lens is open and the left lens is closed. The image speed is 24 frame/second in a regular movie. The image speed is 48 frame/second in 3D movie. 1, 3, 5 . . . (odd numbered frames) are for left eye, 2, 4, 6 . . . (even numbered frames) are for the right eye.

| Advantages | Disadvantages |
|---|---|
| + 3D images are showed in | − Frame ratio is reduced to %50 |
| full resolution | − The goggles are active and |
| + The colors are very natural | require batteries |
| + The extra specified screen | − Goggles have to be synchronized |
| is not necessary | with the screen |

### Stereoscopic Display:

Stereoscopic displays allow 3D images without any goggles. The image couples are separated vertical strips. Then these stripes are sent to screen side by side. Screen user interface has a lenticular system. The lenticular system realises the suitable angle for the eyes. Our eyes and brains sense and combine these image stripes as 3D images.

| Advantages | Disadvantages |
|---|---|
| + No goggles are | − Very expensive |
| necessary | − The user must be stable on screen, must |
| | not move |
| | − Resolution is very low |

Today, there are one or more cameras on smartphones side by side. So you can take selfie photos and make video calls by front camera(s). Also you can take scenery photos and videos by back camera(s). It is possible to take just 2D photos and videos by cameras that are placed side by side, not 3D photos and videos.

On the other hand, you can record 3D images with smartphones by using extra hardware equipment. But you can't watch without special software.

In the other hand, there are some softwares these are called Cyberlink, PowerDVD 10 etc. to convert 2D movies to 3D movies. These programs are used in TrueTheater 3D mode. So, you can watch a 2D movie that is converted to a 3D movie. But these types of softwares are just for

TV or PC. There are not any software for smartphones yet.

The other usage area of this invention is Virtual Reality (VR). Virtual Reality idea is offered in 1962 by Morton Heilig who made the machine that is called Sensorama. Sensorama was a sensory-based (seeing, hearing and touching) machine. Technically, Virtual Reality means that a person senses 3D environment that is created by PC. User enters a virtual reality environment by using any peripherals as display, helmet, special gloves etc. When user enters the VR environment, user loses touch with reality. For a good VR experiment, VR environment designs must be perfect. Otherwise, user will not be satisfied.

AR applications are classified according to intensity of the sensation of reality. The categories are below:

Partial participation environment: This method puts some Augmented Reality objects to real environment scene. So, It creates a very high quality sense of reality without losing touch with reality. For example, flight simulators. In flight simulators, there are some physical elements in a wide display that also provides some virtual objects, cockpit environment etc. User does not have to use any extra equipment as helmet, special gloves etc.

### CAVE—Computer Assisted Virtual Environment:

This method stimulates all the available senses of the user. CAVE system has wall and floor projections, surround sound systems and some detectors. Helmet, joystick, tactile feedback gloves etc. may be additional equipment.

Mutual Participation Environment: This environments are very large virtual networks. It lets people in different professions interact and share opinions with others such as doctors, engineers, architects, artists etc.

There are lots of virtual reality and augmented reality applications for smartphones. We are focused to augmented reality applications. Up until now, all AR softwares are written using one camera on smartphone. These softwares put augmented reality objects to special tag that is placed to a background. That is why if any object is inserted between camera and tag, augmented reality objects disappear.

According to our research about 3D smartphones, we find US2018020208 (A1) numbered application. A mobile terminal including a touch screen located on a front side of the mobile terminal; a rear body located a rear side of the mobile terminal, the rear body including at least one hole; a bracked accommodated between the front body and the rear body, the bracked formed as a unibody, the bracket including third and fourth holes corresponding to the at least one hole; a first camera coupled with the bracked, the first camera positioned at the third hole of the bracked; a second camera coupled with the bracked, the second camera positioned at the fourth hole of the bracked;a camera flash positioned between the first and second cameras; a main printed circuit board (PCB) including electronic components and electronic circuits for operation of the mobile terminal; a camera pcb coupled with the first and second cameras; and a connector extended from the camera PCB and electrically connected to main PCB. Further, the first and second cameras and the camera flash are placed alongside of an edge of the rear body, and the first and second cameras and the camera flash face a rear of the rear body. As you see, this invention can take 3D images without on eyes position and distance, and has no augmented reality feature.

Another one is CN107872665 (A) numbered application. An embodiment of the invention discloses a mobile phone 3D (three-dimensional) photographing function and a mobile phone 3D photographing system. The mobile phone 3D photographing function is implemented by the aid of a first camera and a second camera which are arranged in a mobile phone side by side. The mobile phone 3D photographing function includes acquiring first video frame pictures shot by the first camera and acquiring second video frame pictures shot by the second camera;

correspondingly acquiring odd and even pixel points of pixels of the first video frame pictures and pixels of the second video frame pictures and arranging the odd and even pixel points in the same coordinate to synthesize 3D video frame pictures; generating 3D video according to the 3D video frame pictures; outputting the 3D video. The mobile phone 3D photographing function and the mobile phone 3D photographing system have the advantage that 3D video film sources can be directly generated when video is shot by the mobile phone. Mentioned cameras are very close to each other and it is unsuitable for the distance between eyes. That's why it can take 3D pictures of objects only very close to camera.

The other invention is 2016/19631 numbered: This machine includes at least one back camera and one front camera and one processor for recording 3D video. If 3D mode is activated, both two cameras are activated and sequential images recorded, aligned and re-scaled and then presented to user. Any extra equipment is not necessary. But in this invention, 3D means panoramic image.

The other invention is 2010/03122 numbered: It's related to a machine that can take photos and and record videos in 3D by a standard camera. This invention is not related to smartphone.

The last one is 2016/15074 numbered: This invention is related to virtual trips and making reservations by using Virtual Reality Technology in 3D. The system consists of 360 VR, servers and data base that contains 3D videos of environments using IP connections and reservation and payment details. This invention is related to Virtual Reality, not Augmented Realty.

### Goal of The Invention

This invention is related to a more advantaged method for taking 3D photos and videos via integrated double front cameras and double back cameras on the smartphone.

Main goal of the invention is to take 3D photos and record videos by double cameras which are distant between 45-75 mm (approximately two eyes distant) in horizontal position and at eye level with 360 VR.

The another goal is to put some augmented reality objects into a preferred depth in the environment scene. The other hand, the smartphone is used in 360 VR for handsfree. So user can take notes or use equipments such as screwdrivers, pincers or any other tools.

### DRAWINGS

FIG. 1: Front view of the smartphone that has double front cameras.

FIG. 2: Back view of the smartphone that has double back cameras.

FIG. 3: How the smartphone is used in 360 VR

FIG. 4: How the smartphone takes photos and records videos from stereo cameras, then sends to display.

FIG. 5: How the software selects areas of stereo cameras according to distance to objects, and according to angles.

### REFERENCE OF PARTS

| | |
|---|---|
| 10. | Smartphone |
| 11.A. | Front Left Camera |
| 11.B. | Front Right Camera |
| 12.A. | Back Left Camera |
| 12.B. | Back Right Camera |
| 20. | Display |
| 30. | Object |
| 40. | 360 VR |
| 1. | Far Angle |
| 2. | Medium Angle |
| 3. | Close Angle |

### DETAILED EXPLANATION OF INVENTION

Human percepts depth because of two eyes. If one of two eyes is closed, people can not sense which one of same looking objects is closer and the other one is further.

If you close the left eye and right eye sequentially, images are different from each other because of distance of the eyes. Left eye sees left side of the object, right eye sees right side of the object. Depth perception and 3D view consists of these two different images. That's why any 3D photo, video or selfie photo, selfie video can be taken by the two cameras. Likewise, the software can put any augmented reality object in the right depth of the taken photo or video, because of these two cameras.

So the two cameras (12 A-B) must be placed 45-75 mm distant from each other, on the back of smartphone for taking 3D photos and videos.

In the same way, the other two cameras (11 A-B) must be placed 45-75 mm distant from each other in front of the smartphone for taking 3D selfie photos and selfie videos.

FIG. 2 shows the settlement of two cameras on back of the smartphone (10). Back left camera (12 A) and back right camera (12 B) are located on back of the smartphone (10) as two eyes in horizontal position. 3D photos and videos can be taken, because of back left camera (12 A) and back right camera (12 B). The 45-75 mm distance of back left camera (12 A) and back right camera (12 B) enables to take 3D photos and videos. That's why two eyes and two cameras have the same principle for recording and real-time video shoot.

FIG. 4 shows how the back cameras (12 A-B) of smartphone (10) can percept, take and send to display (20). Back left camera (12 A) and back right camera (12B) see the object (30) in different Angeles than each other. These images are sent to display as received. Display (20) is divided into two equal parts for these two different images.

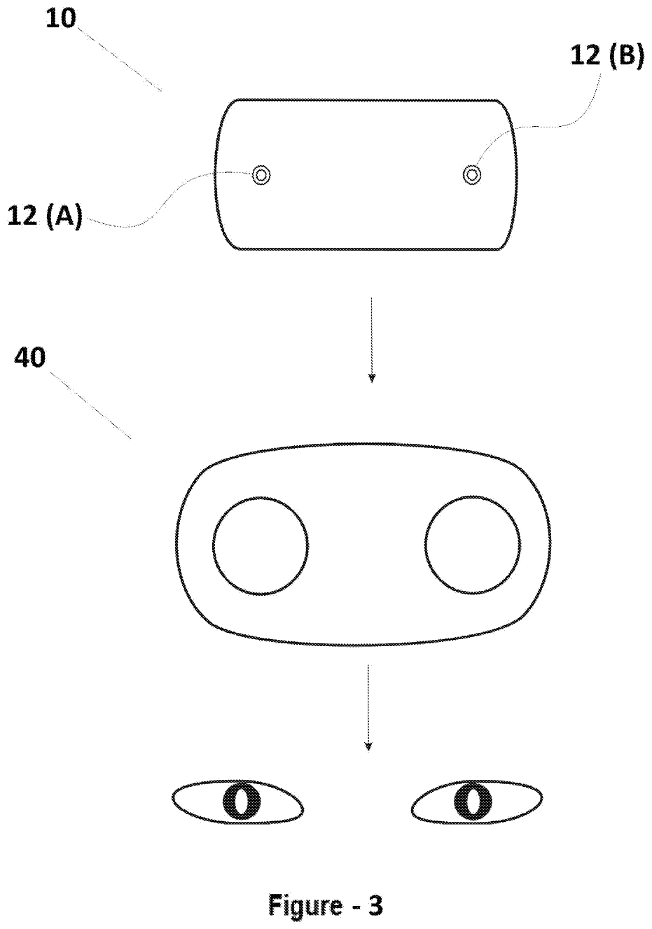

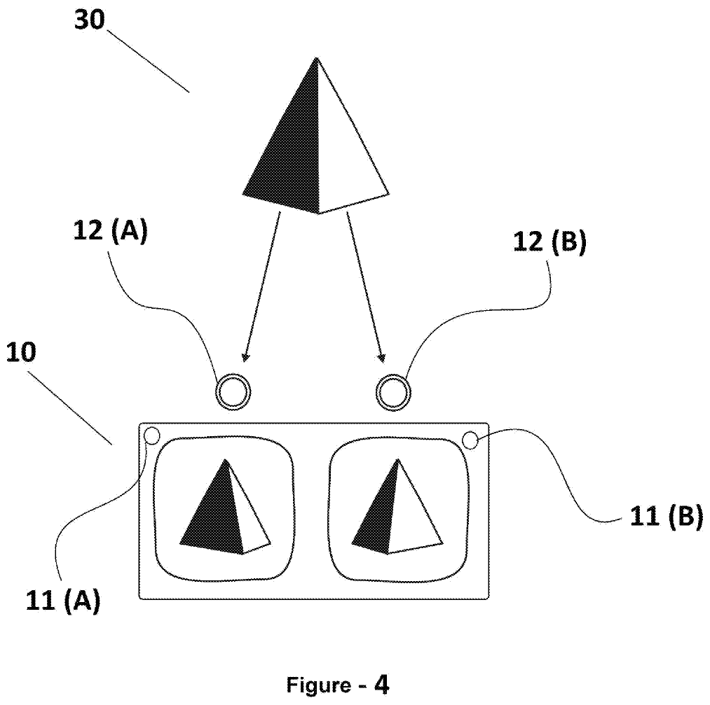

FIG. 3 is the exploded picture of smartphone (10) that is connected to 360 VR (40). User can watch 3D images on display (20) from the back left camera (12 A) and the back right camera (12 B), with smartphone (10) that is in 360 VR (40).

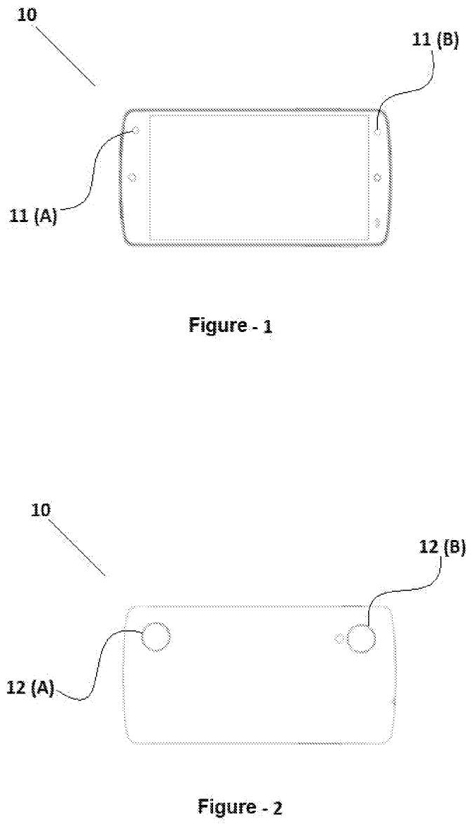

FIG. 1 shows the settlement of two cameras on front of the smartphone (10). The front left camera (11 A) and the front right camera (11 B) are located on front of the smartphone (10) like two eyes in horizontal position. The front left camera (11 A) and the front right camera (11 B) come into play and take 3D images of environment during bidirectional video call.

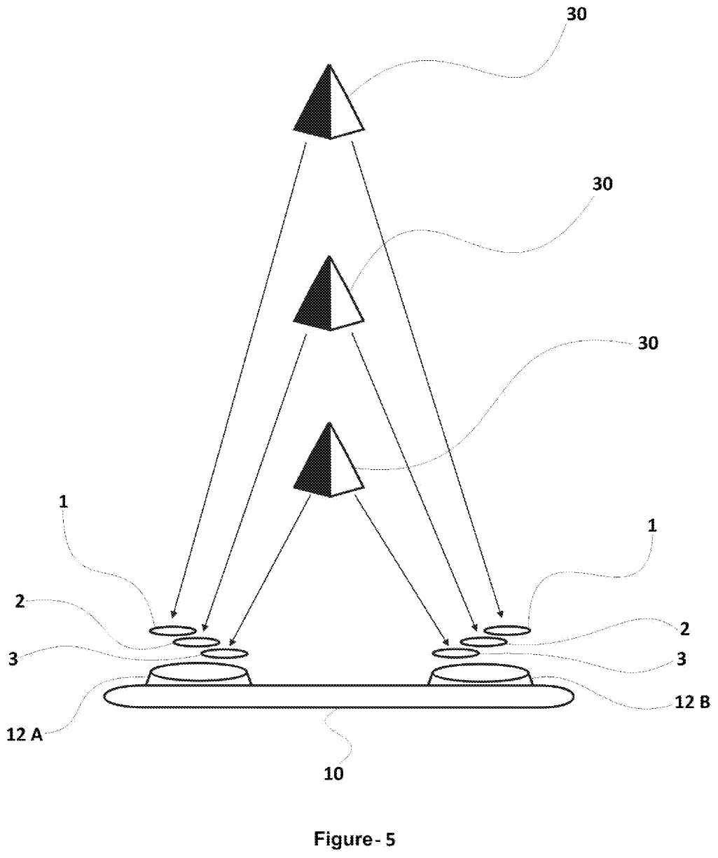

FIG. 5 shows the areas left and right cameras focus and shows how the software selects the areas of stereo cameras according to the distance of objects (30) and according to angles. That means the cameras focus on objects (30) depends on if the distance of the object is far (1), medium (2) or near (3). This distance determines where the augmented reality objects are placed by the software. The same way, the software minimizes the amount of blind spots of environment images that are taken by the front cameras (11 A-B) and/or back cameras (12 A-B), according to the distance.

The smartphone cameras run in three working principles. These are CSI, CSI-2 and CSI-3 (Camera Serial Interface). This invention method works in the same principles and the data flow chart is shown below.

| | | |
|---|---|---|
| Front Left | Smartphone | Back Left |
| Camera | Main | Camera |
| (11A) | Board | (12 A) |
| Front Right | | Back Right |
| Camera | | Camera |
| (11B) | | (12 B) |

1. The invention is the smartphone (10) that has a method to enable to take photographs and videos in 3D, wherein smartphone (10) has left camera (12 A) and right camera (12 B) on back sides, these cameras are distant between approximately 45-75 mm as two eyes distance in horizontal position.

2. The invention is the smartphone that has a method to enable to take photographs and videos in 3D according to claim 1, wherein smartphone (10) has left camera (11 A) and right camera (11 B) on front sides, these cameras are distant between approximately 45-75 mm as two eyes distance in horizontal position.

3. The invention is the smartphone that has a method to enable to take photographs and videos in 3D according to claim 1, wherein smartphone (10) includes software application(s) to minimise blind points, when the object (30) comes closer to smartphone back left camera (12 A) and right camera (12 B).

4. The invention is the smartphone that has a method to enable to take photographs and videos in 3D according to claim 1, wherein smartphone (10) has front left camera (11 A), front right camera (11 B) and, back left camera (12 A), back right camera (12 B), these take photos and videos of object (30) in different angles like two eyes and send these images from different angles to the display (20) of the smartphone (10) for two eyes.

5. The invention is the smartphone (10) that has a method to enable to take photographs and videos in 3D according to claim 1, smartphone (10) is used in 360 VR (40) for handsfree usage.
